(19) United States
(12) Patent Application Publication
(10) Pub. No.: US 2011/0005902 A1
(43) Pub. Date: Jan. 13, 2011

(54) ROLLER CONVEYOR AND A ROLLER PATH SYSTEM THEREFOR

(75) Inventors: Steffen Kobs, Ehningen (DE); Werner Swoboda, Boeblingen (DE)

Correspondence Address: FACTOR & LAKE, LTD, 1327 W. WASHINGTON BLVD., SUITE 5G/H, CHICAGO, IL, 60607, US

(73) Assignee: EISENMANN ANLAGENBAU GMBH & CO. KG, Boeblingen (DE)

(21) Appl. No.: 12/839,226

(22) Filed: Jul. 19, 2010

Related U.S. Application Data
(63) Continuation-in-part of application No. 12/089,117, filed on May 7, 2008.

(30) Foreign Application Priority Data
Oct. 4, 2005 (DE) 102005047530.2

(51) Int. Cl. B65G 13/02

(52) U.S. Cl. 198/780

(57) ABSTRACT

The roller conveyor for transporting good carriers, in particular skids used in the automobile industry, comprises a conveyor path consisting of several in series arranged roller path modules. Each roller path modules comprises two roller borders which are parallel to each other and between which at least one transport roller is arranged. The roller conveyor also comprises an operation unit movable with respect to the conveyor path. According to said invention, the operation unit is embodied in a modular manner and comprises the roller path module and moving gear modules fixed thereto.

### RELATED APPLICATIONS

This application is a continuation-in-part application based on U.S. Ser. No. 12/089,117, filed Apr. 3, 2008, which national phase application based on International Patent Application No. PCT/EP2006/009366, filed Sep. 27, 2006, which claims the filing benefit of German Patent Application No. 10 2005 047 530.2 filed Oct. 4, 2005, the contents of all of which are incorporated herein by reference.

### TECHNICAL FIELD

The invention relates to a roller conveyor for transporting goods carriers, in particular “skids” in the automotive industry, comprising
a) a conveyor path, which is formed from a plurality of roller path modules arranged in series, the roller path modules respectively comprising two roller strips which are parallel to one another, in which at least one driven transport roller is arranged, and comprising
b) an operation unit which is movable relative to the conveyor path.

### BACKGROUND OF THE INVENTION

Such roller conveyors are used for transporting goods carriers, such as for example pallets. In the automotive industry, vehicle bodies or parts of vehicle bodies are frequently trans-ported thereby between individual operating stations. The vehicle bodies are in this case fastened to so-called “skids”. Transport frames are denoted thereby which have two skid runners parallel to one another. The skid runners bear on rollers of the roller conveyor during the conveying process, which are arranged in pairs and in series in the direction of conveyance. If the rollers are set in rotation by drives, the skid is conveyed with the vehicle body fastened thereto in the direction of conveyance.

The known roller conveyors are made up of individual roller path modules, which respectively contain a separate electrical drive motor. The drive motor is generally arranged between parallel roller strips, in which the rollers are accommodated. Generally, the torque generated by the drive motor is distributed via belts to the driven rollers of one of the two roller strips. Said rollers are rigidly connected via axles to the rollers on the other roller strip.

Frequently, such roller conveyors have operation units which are movable relative to the conveyor path. Generally in this connection said operation units are longitudinal or transverse sliding carriages or turntables or swivel tables. By means of such operation units, it is possible for example to link a plurality of conveyor paths together in the manner of a network or to distribute goods carriers to storage points as in a shunting yard.

The operation units were hitherto individually constructed devices comprising a running gear in addition to driven, and possibly also non-driven, transport rollers, in order to be able to move the operation unit relative to the conveyor path.

### SUMMARY OF THE INVENTION

It is an object of the invention to improve the variability and modularity of the known modular roller path systems.

This object may achieved in a roller path system of the aforementioned type, in that the operation unit is constructed from a roller path module and running gear modules fastened thereto. The running gear modules may in this case be fastened to the roller path module directly or via intermediate members. Such intermediate members may, if required, also be regarded as detachable components of the running gear modules.

According to the invention, the operation unit is thus no longer constructed as a relatively complex complete unit, but constructed on the basis of a roller path module used for the conveyor paths. By fastening the running gear modules to the standard roller path modules, more complex operation units such as turntables or swivel tables as well as longitudinal and transverse sliding carriages may therefore be constructed in a simple manner. This considerably simplifies the construction, the storage of individual parts and also the assembly of the roller conveyor. The upgrading of a standard roller path module into a more complex operation unit is even possible at the point of operation of the roller conveyor.

In order to allow the mobility of the operation unit, the running gear modules have devices which allow a movement relative to the fixed conveyor paths. Said devices may, for example, be linear ball bearings or electromagnets, which allow a contactless suspension of the operation unit in a similar manner to magnetic levitation railways.

However, it is particularly simple and cost-effective if the running gear modules have rollers on which the entire operation unit may be moved on a suitable base or on rails. The arrangement and alignment of the rollers on the running gear modules determines, therefore, how the entire operation unit is able to move.

If the rollers of the running gear modules have, for example, rotational axes which extend parallel to the longitudinal direction of the roller strips, the operation unit is therefore a transverse sliding carriage which may be moved transversely to the longitudinal direction of the roller strips.

If the rollers of the running gear modules, however, have rotational axes which extend at right angles to the longitudinal direction of the roller strips and parallel to a conveying plane predetermined by the roller strips, a longitudinal sliding carriage is created from the roller path module which may be moved in the longitudinal direction of the roller strips.

In principle, with rotational axes of the rollers arranged longitudinally or transversely to the longitudinal direction of the roller strips, turntables or swivel tables may also be constructed. An improved support and more advantageous running properties are, however, achieved if the rollers of the running gear module fastened to the roller path modules have rotational axes which extend parallel to a conveying plane predetermined by the roller strips and obliquely to the longitudinal direction of the roller strips. Furthermore, the roller path system may comprise curved runners for the rollers as further modules. The radius of the runners may in this case be relatively large, as a result of which an effective support of the turntable or swivel table is ensured.

If the running gear modules are releasably connected to the roller path module, therefore, there is the possibility of converting operation units into different operation units by retrospectively exchanging running gear modules. As a result, the roller conveyor may be converted in a simple manner at the point of operation, in order to take account of changed requirements. Roller path modules and possibly also running gear modules which are already present may also be possibly used again with such a conversion.

It is most advantageous if in the operation unit the running gear modules are fastened to the roller path module such that they have the same spacing from the front faces thereof. In this manner, a symmetrical arrangement is achieved which ensures a uniform force distribution. Such a symmetrical arrangement is even obligatory when constructing turntables. Advantageously such a symmetrical arrangement may also be provided with regard to additional parts such as covers, or the like, which also may be provided in standard sizes.

In accordance with a force distribution which is as advantageous as possible, in the operation unit, the running gear modules should be fastened to the roller path module such that they extend parallel to a plane fixed by the roller strips, outwardly away from the roller path module.

Structurally, it is simplest if in the operation unit, the running gear modules are fastened to side cheeks of the roller strips. As an alternative, however, the running gear modules may also be fastened beneath the roller strips.

In order to simplify the assembly of the operation unit at the point of operation, stops for aligning the running gear modules or intermediate members connected thereto may be configured on the roller path modules.

If the roller strips are connected to one another in the transverse direction by transverse members, there is the possibility in the operation unit of fastening the running gear modules to the ends of the transverse members.

It is even more advantageous if the roller strips have through-passages which extend transversely to the longitudinal direction of the roller strips. Crossmembers which are connected to the running gear modules may be inserted into the through-passages.

If a transverse member is present between the roller strips, said transverse member may advantageously be arranged between opposing through-passages of the roller strips, such that it is used as a stop for such a crossmember. The transverse members themselves are preferably releasably connected to the roller strips. This is advantageous as the roller path modules made up of smaller sub-assemblies, namely the roller strips and the transverse members, may be assembled at the point of operation of the roller conveyor. Thus it is possible to assemble roller path modules which, due to their transport volume, would only be able to be transported with greater difficulty to the point of operation.

A particularly good stop effect is achieved if the transverse members have a hollow profile or U-shaped profile, into which the crossmember is inserted.

In a particularly advantageous embodiment of the invention, in the operation unit respectively two running gear modules are fastened to one crossmember which extends at least over the entire width of the roller path module and is accommodated in the through-passages of the roller strips. The transverse member thus represents an intermediate member to which the running gear modules may be fastened.

In this embodiment, two running gear modules may be very easily fastened to the roller path module at the same level in a manner such that the crossmember is initially passed through the through-passages. The crossmember, therefore, preferably bears against suitably configured stop surfaces on the roller strips and may be fastened in this position by screw connections or in any other manner to the two roller strips. Subsequently, the two running gear modules are fastened to the inserted crossmembers and namely preferably to the free ends thereof. In this manner, the running gear module may be fastened to a roller path module in a manner which is very stable and may be rapidly assembled.

In this embodiment, the crossmembers and/or the roller strips may preferably be configured as U-shaped profiles. As a result, the entire operation unit obtains a very torsionally rigid and nevertheless lightweight construction.

U-shaped profiles have, moreover, the advantage that the inside of the profiles is more easily accessible, in order to attach screw connections and the like or to lay electrical cables. It is also advantageous from the last-mentioned point of view if the U-shaped profiles of the roller strips are arranged such that their open side faces upwardly. This open side may, if required, be closed by covers, after all assembly operations which require access to the inside of the profiles are completed.

Covers may, however, also be fastened to the roller strips which cover the entire space between the roller strips and which preferably all have the same dimensions.

The covers may in the longitudinal direction of the roller strips have dimensions which substantially correspond to the spacing between the transport rollers. So that the same covers may also be used at the joins between the adjacent roller path modules, the spacing between the transport rollers should be double the size of the spacing between the front faces of the roller path modules and the last transport rollers on the front face.

The modular construction of the roller conveyor comes to bear particularly advantageously if the roller conveyor has a plurality of different operation units which are constructed on the basis of the same roller path module, and differ from one another substantially only by the running gear modules fastened thereto. As, as already mentioned, the mobility of the operation units is finally only established by the arrangement of the rollers relative to the roller strips, it is sufficient in principle to configure the running gear modules as simple holders, in which rollers are held with different orientations. These holders may, therefore, if required, be connected via additional intermediate members to the roller strips.

A further differentiation of the running gear modules may be made from the point of view of whether the rollers are driven or not driven. When using hub drives, the same holders may be used both for driven and for non-driven rollers. In this manner, the modularity of the entire system is further increased.

The construction of the roller strips is considerably simplified if each driven transport roller has its own drive, for example in the form of a hub drive. The relatively costly and maintenance-intensive use of belts for transmitting the drive torques between adjacent rollers may therefore be dispensed with.

In order to allow an automatic movement of the roller path module in the movement plane, at least one roller of an operation unit should have a separate drive. Preferably, in this case it is also a hub drive. Such a hub drive makes it possible both for the rollers and for the transport rollers to use identical sub-assemblies consisting of a roller and a hub drive. This allows in turn a very compact and modular construction of the entire operation unit.

When using the same sub-assemblies for the transport rollers and for the rollers, the power supply and control of the rollers may also be carried out in the same manner. Thus all roller sub-assemblies may be connected to the same power supply and the same control device.

Preferably, these roller sub-assemblies may be connected to one another such that on the front faces of the roller path modules respectively one single electrical connection is present for the power supply of all drives and a single connection is present for controlling the drives. These connections may, therefore, be connected to the connectors of a roller path module adjacent thereto. The connection is particularly simple when the connectors are configured as releaseable connections.

It is also advantageous if each roller path module has at least two driven transport rollers. If the skids are not substantially shorter than the roller path modules, in this manner it is ensured that every skid at any point in time bears on at least two driven transport rollers. If one of the transport rollers fails, the remaining transport roller is at least able to convey the skid in an emergency operation.

The subject of the invention is also a roller path system which may be used for constructing a roller conveyor, as has been described above. The modular roller path system comprises a plurality of roller path modules, from which a conveyor path may be constructed by arranging along a line. The roller path modules respectively comprise two roller strips parallel to one another and contain at least one driven transport roller. According to the invention, additional running gear modules are provided from which an operation unit may be constructed which is movable relative to the conveyor path, by fastening to a roller path module.

If the roller path system comprises different sets of running gear modules, different operation units such as longitudinal and transverse sliding carriages or turntables and swivel tables may be constructed by fastening the running gear modules to a roller path module.

Overall, therefore, a modular roller path system is provided in which from a few modules complex roller conveyors including corresponding operation units such as turntables and swivel tables and longitudinal and transverse sliding carriages may be constructed.

It is to be understood that the aspects and objects of the present invention described above may be combinable and that other advantages and aspects of the present invention will become apparent upon reading the following description of the drawings and detailed description of the invention.

### BRIEF DESCRIPTION OF THE DRAWINGS

FIG. 1 shows a perspective view of a roller path module according to the invention according to a first embodiment of the invention;

FIG. 2 shows a perspective view of a transverse sliding carriage which is constructed on the basis of the roller path module shown in FIG. 1;

FIG. 3 shows a perspective view of a longitudinal sliding carriage which is constructed on the basis of the roller path module shown in FIG. 1;

FIG. 4 shows a perspective view of a turntable which is constructed on the basis of the roller path module shown in FIG. 1;

FIG. 5 shows a perspective view of a swivel table which is constructed on the basis of a roller path module shown in FIG. 1;

FIG. 6 shows a plan view of a roller path module according to a second embodiment of the invention;

FIG. 7 shows a section through a roller strip of the roller path module shown in FIG. 6 along the line VII-VII;

FIG. 8 shows a section through a transverse member of the roller path module shown in FIG. 6 along the line VIII-VIII;

FIG. 9 shows a section through a roller strip of the roller path module shown in FIG. 6 along the line IX-IX; and,

FIG. 10 shows a schematic view of a conveyor path system in accordance with the present invention.

### DETAILED DESCRIPTION OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

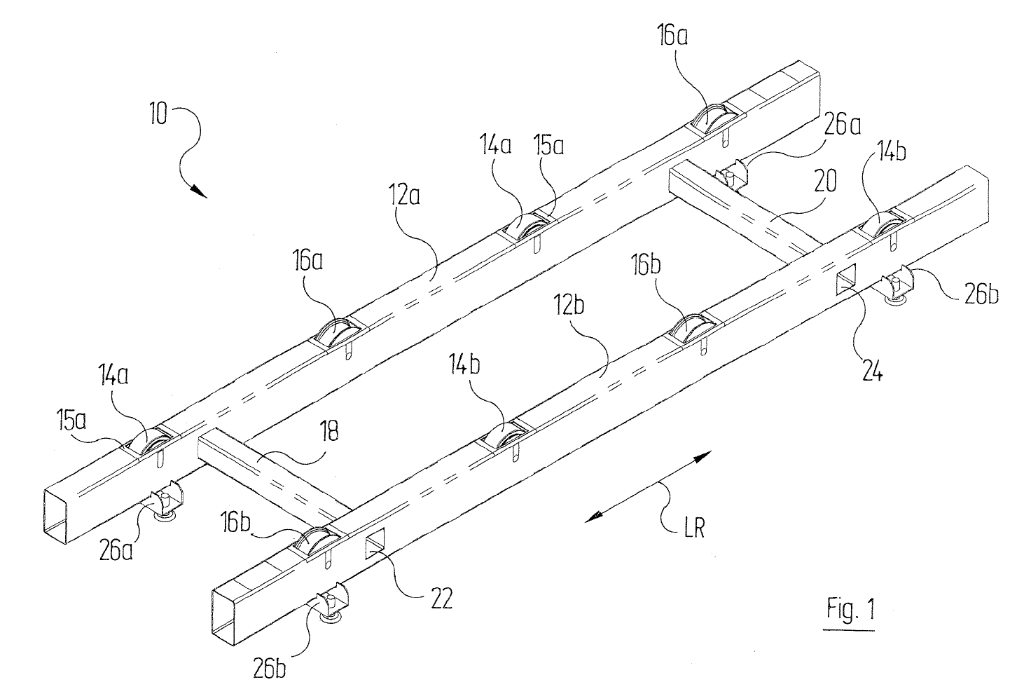

In FIG. 1 a first embodiment of a roller path module according to the invention is shown in perspective and denoted as a whole by 10. The roller path module 10 has two roller strips 12a, 12b which are respectively hollow profiles of rectangular cross section. In the roller strip 12a two driven transport rollers 14a and two non-driven transport rollers 16a are alternately arranged in a longitudinal direction indicated by a double arrow LR. To each of the driven transport rollers 14a is associated a separate electrical hub drive which forms a compact sub-assembly with the transport rollers 14a. These sub-assemblies are, during the assembly of the roller strip 12a, inserted into recesses which are exposed on the upper face of the roller strip 12a, for example by laser cutting. After inserting these units, gaps remaining between the transport rollers 14a and the upper face of the roller strip 12a may be reduced by inserting a rectangular frame part 15a.

The same applies also to the non-driven transport rollers 16a except that said non-driven transport rollers do not have a hub drive.

The profiles of the driven transport rollers 14a may have a different form from the profiles of the non-driven transport rollers 16a. In particular it is advantageous if the driven transport rollers 14a are provided with a coating which generates a high degree of friction.

The hub drives of the driven transport rollers 14a are connected to one another via a common power supply unit, but may be controlled individually via a control bus. Preferably the cables for the power supply and the control bus run within the roller strip 12a and at the free ends of the roller strips 12a feed into suitable plug contacts (not shown), in order to allow a simple connection to adjacent roller path modules.

The other roller strip 12b is designed in a similar manner, except that the driven transport rollers 14b are arranged offset to the driven transport rollers 14a of the roller strip 12a such that a driven transport roller 14a, 14b respectively opposes a non-driven transport roller 16b and/or 16a at the same level in the longitudinal direction LR.

The arrangement described above of the driven and non-driven transport rollers is only given by way of example. Generally, this arrangement of roller conveyors primarily depends on the type and dimensions of the goods carriers to be conveyed, the weight of the objects to be transported thereon and also on the drive power of the roller drives. With the skids located in this case in the foreground, other arrangements are also considered. Thus instead of the offset arrangement the driven transport rollers may also be arranged respectively parallel, i.e. located at the same level. More or fewer non-driven rollers may also be present than has been described above.

The two roller strips 12a, 12b are rigidly connected to one another via two transverse members 18, 20. The transverse members 18, 20 are welded to the roller strips 12a, 12b or fastened in a different manner, for example by screw connections. In the embodiment shown in FIG. 1, the transverse members 18, 20 are also configured as hollow profiles which in this case have a square cross section. On the vertical side cheeks of the roller strips 12a, 12b, level with the transverse members 18, 20 square recesses are provided which extend through the roller strips 12a, 12b. These recesses are aligned with the internal profile of the transverse members 18, 20, so that in total, two through channels 22 and/or 24 are produced which extend over the entire width of the roller path module 10. The channels 22, 24 serve as a receiver for crossmembers which are pushed from the side into the channels 22, 24 and then, in a manner not shown in more detail, are fastened for example by screw connections or welding. The importance of the crossmembers which may be inserted into the channels 22, 24 is explained in more detail below with reference to the remaining figures.

In the embodiment shown the entire roller path module 10 is fastened to floor members 26a, 26b, which encompass the roller strips 12a, 12b from below. The floor members 26a, 26b are fastened to an assembly base or a similar supporting structure and may be adjusted heightwise for compensating for floor unevenness.

For constructing a roller conveyor, a plurality of roller path modules 10 are arranged in series. Then the electrical connections at the ends of the roller strips 12a, 12b are connected to the corresponding connections of the adjacent roller strips 12a, 12b. Subsequently, the roller strips 12a, 12b of the adjacent roller path modules on the front face are connected to one another, for which for example guide shoes may be used which may be inserted into the hollow profiles. In a further step, the floor members 26a, 26b are fastened in their final position according to the exact alignment of the roller path modules and levelled heightwise. After the connection of the roller path modules 10 to a power supply unit and to a control unit, it is possible to carry out the conveying operation. In this manner, a roller conveyor may be constructed very rapidly and with low assembly costs at the point of operation, which may be converted in a versatile manner due to its modular construction.

The objects to be conveyed by the roller conveyor may, in particular, be skids which in turn carry motor vehicle bodies or preassembled motor vehicles. The skids are provided on their underside with runners with which they bear against the driven and non-driven transport rollers 14a, 14b and/or 16a, 16b. The runners of the skids are in this case sufficiently long that they always bear on at least two transport rollers, preferably on three or even four transport rollers. By the alternate arrangement of the driven and non-driven transport rollers 14a, 14b and/or 16a, 16b it is ensured that, in this layout, each runner of the skid is always driven by at least one transport roller. It has proved advantageous if the roller path modules 10 have a total length which is slightly greater than the length of such skids. With a skid length of 5 metres, the roller path module 10, for example, may have a length of 6 metres.

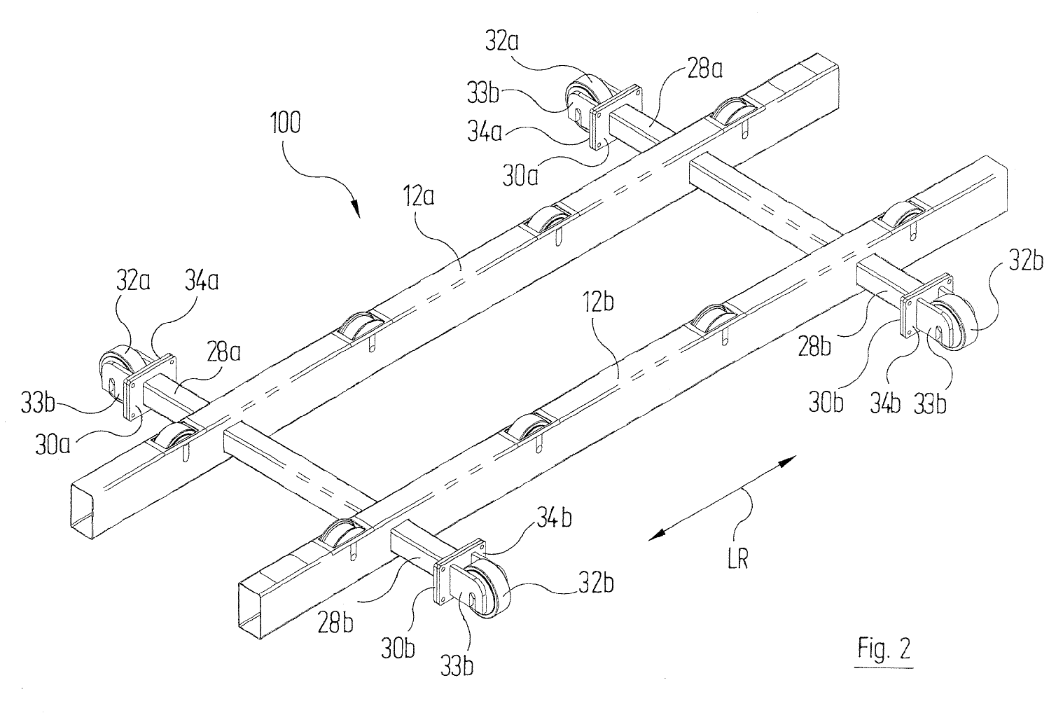

As has already been mentioned, the channels 22, 24 running at the same level as the transverse members 18, 20 serve to receive crossmembers with which the roller path modules 10 may be further extended and converted into different operation units. Hereinafter, different possibilities are described with reference to FIGS. 2 to 5, which operation units may be constructed on the basis of the roller path modules 10.

In FIG. 2 a transverse sliding carriage 100 which is constructed on the basis of the roller path module 10 is shown in a perspective view according to FIG. 1. For constructing the trans-verse sliding carriage 100, crossmembers 28a, 28b are pushed into the channels 22, 24 on both sides of the roller strip 12a, 12b and fastened releaseably or even unreleasably in their pushed-in position in a manner not shown in more detail. On the opposing ends, the crossmembers 28a, 28b bear connecting flanges 30a and/or 30b. If the roller path module 10 is intended to be fastened between two vertical walls, the connecting flanges 30a, 30b are used in order to create a screw connection with the walls.

The connecting flanges 30a, 30b may, however, also be used for fastening rollers 32a, 32b which are held in holders 33a, 33b. The holders 33a, 33b for the rollers 32a, 32b have mating flanges 34a, 34b which are screwed to the connecting flanges 30a, 30b of the crossmembers 28a, 28b. The rollers form, together with the holders 33a, 33b, running gear modules which may be screwed as preassembled units to the connecting flanges 30a, 30b.

In the case shown in FIG. 2, the rotational axes of the rollers 32a, 32b extend parallel to the longitudinal direction LR. The two rollers 32a on one side of the roller path module 10 are respectively provided with individual hub drives. In detail, in this case they are the same sub-assemblies which are also used for the driven transport rollers 14a, 14b.

The entire unit shown in FIG. 2, driven by the hub drives of the two rollers 32a, may travel transversely to the longitudinal direction LR, as is characteristic for a transverse sliding carriage. With the transverse sliding carriage 100 it is possible to move skids and other goods carriers transversely to the direction of conveyance and, for example, in this manner to change between a plurality of conveyor paths.

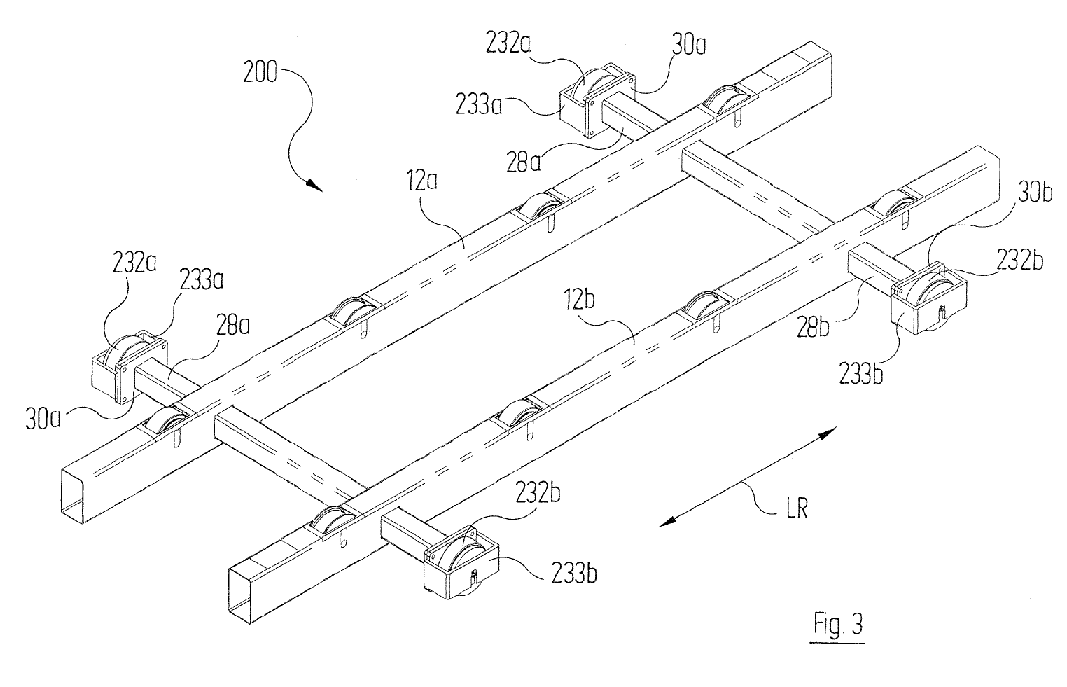

FIG. 3 shows in a perspective view according to FIG. 2 how, by using differently aligned rollers on the basis of the roller path module 10, a longitudinal sliding carriage may be constructed, which is denoted in FIG. 3 as a whole by 200. For constructing the longitudinal sliding carriage 200, holders 233a, 233b for rollers 232a, 232b are fastened to the connecting flanges 30a, 30b of the crossmembers 28a, 28b, the rotational axes thereof extending parallel to the longitudinal direction of the transverse members 18, 20. In this manner, a longitudinal sliding carriage which may be moved in the longitudinal direction LR, may be moved with the objects carried thereon in the longitudinal direction LR together with the roller path module 10.

Also in this case, again two or even a plurality of rollers 30a, 30b may use a single drive as is also the case in the embodiment shown in FIG. 2 for a transverse sliding carriage.

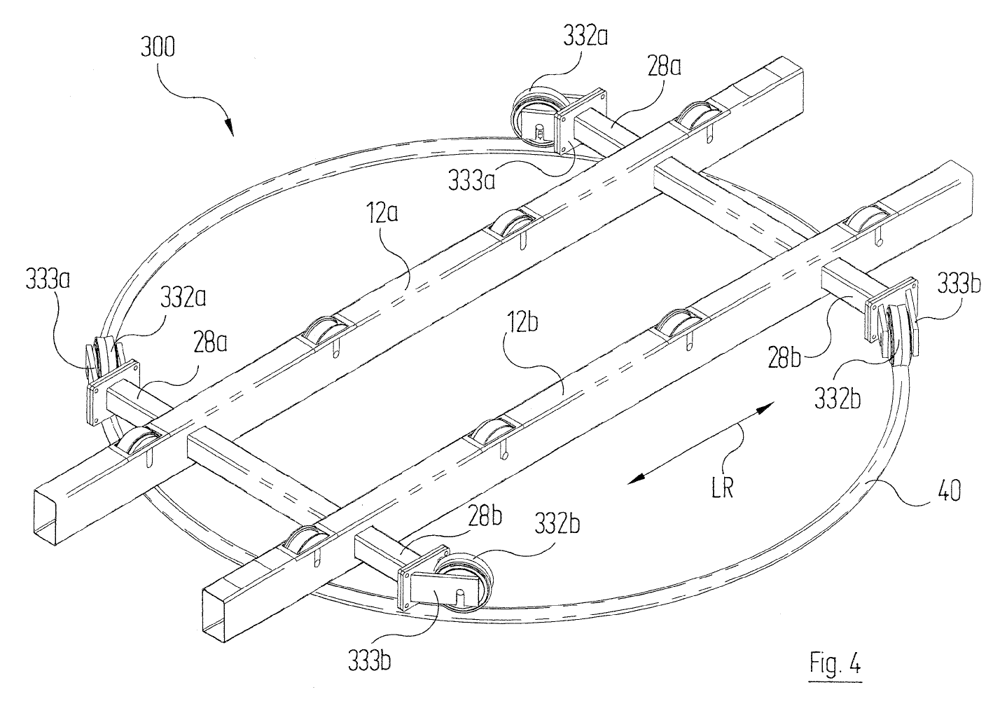

FIG. 4 shows in a perspective view a turntable denoted as a whole by 300, which is also constructed on the basis of a roller path module 10. In the turntable 300, holders 333a, 333b for rollers 332a, 332b are fastened to connecting flanges 30a, 30b of the transverse carriers 28a and/or 28b, the rotational axes thereof adopting an angle of ±30° to the longitudinal direction LR. The arrangement of the rollers 332a, 332b is in this case selected such that diametrically opposing rollers have coaxial rotational axes. In this manner, the rollers 232a, 232b are located on a circular path whereby a rotation of the roller path module 10 is possible about a perpendicular axis of symmetry. For guiding the running wheels 232a, 232b the turntable 300 has a circular runner 40 on which the rollers 232a, 232b roll in a guided manner. Also in this case two rollers 232a, 232b are preferably again provided with hub drives.

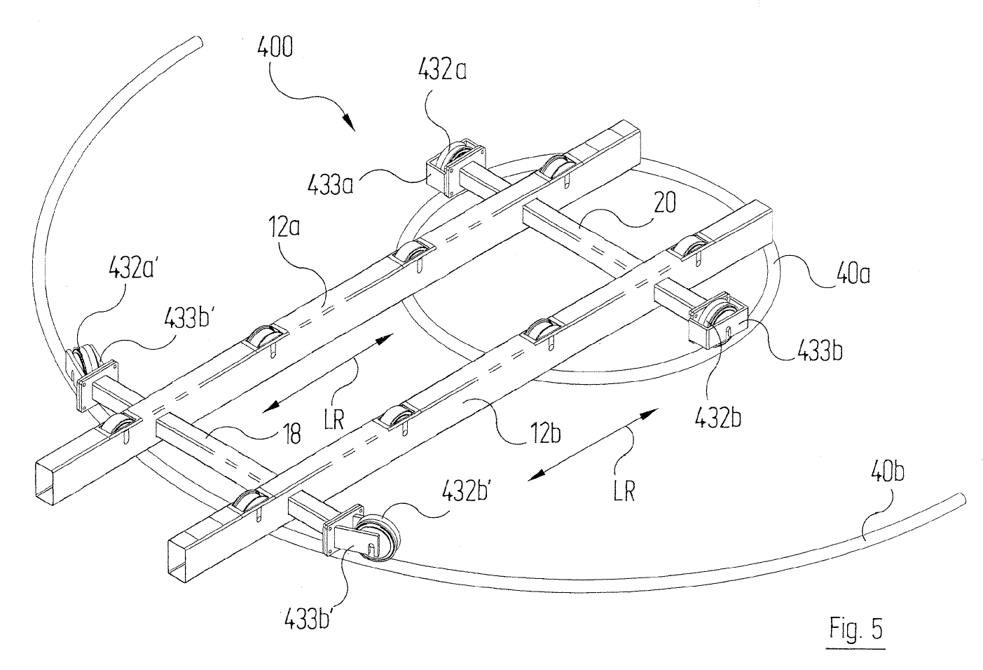

FIG. 5 finally shows a swivel table denoted as a whole by 400, in a perspective view, which is also constructed on the basis of the roller path module 10. In the swivel table 400, pairs of holders 433a, 433b and 433a′, 433b′ are fastened to the connecting flanges 30a, 30b of the crossmembers 28a and/or 28b, in which the rollers are aligned transversely to the longitudinal direction LR and/or obliquely thereto. At one end of the swivel table 400 the rotational axes of a first pair of rollers 432a, 432b extend transversely to the longitudinal direction LR of the cross-member 20. These two running wheels 432a, 432b run on a circular runner 40a.

At the opposite end of the swivel table 400 the connecting flanges 30a, 30b carry holders 433a′, 433b′ for rollers 432a′ and/or 432b′, the rotational axes thereof in this case, by way of example, enclosing an angle of ±15° relative to the longitudinal direction LR of the roller strip 12a, 12b. These two outer rollers 432a′, 432b′ run on an approximately semi-circular second runner 40b which is arranged concentrically to the first runner 40a.

In the swivel table 400 a pair of opposing running wheels, for example the outer pair 432a′, 432b′ are also provided with separate hub drives so that the swivel table may be swivelled about the centre point of the first runner 40a.

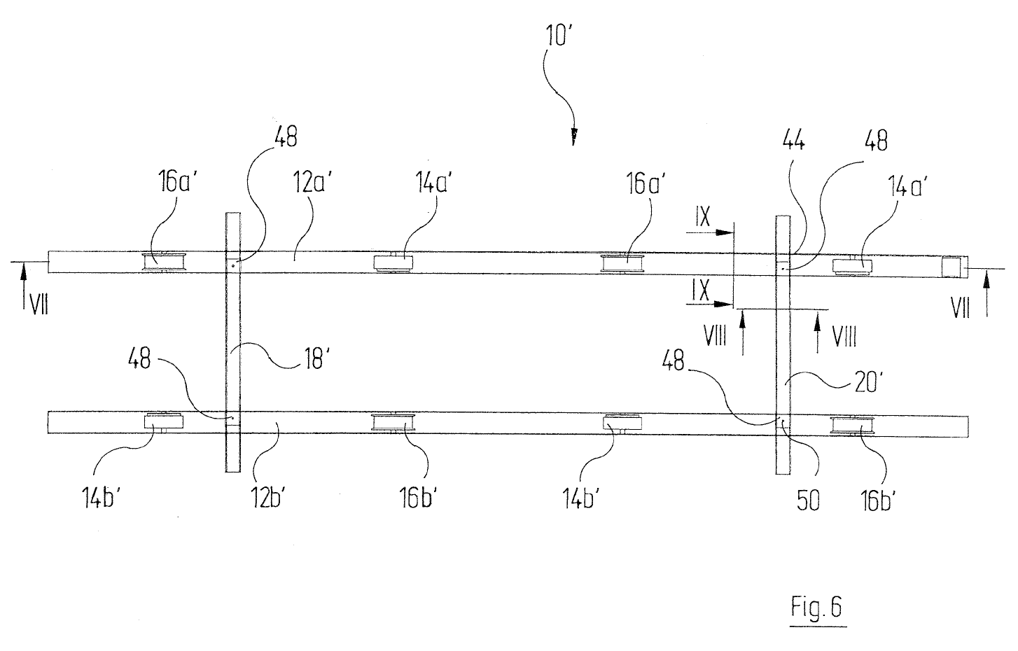

FIGS. 6 to 9 show a roller path module denoted as a whole by 10′, according to a second embodiment of the invention in plan view and/or in sectional view along the lines VII-VII, VIII-VIII and IX-IX. Parts which are the same relative to the roller path module 10 shown in FIG. 1 or which correspond to one another are provided with reference numerals which are supplemented by an apostrophe (′).

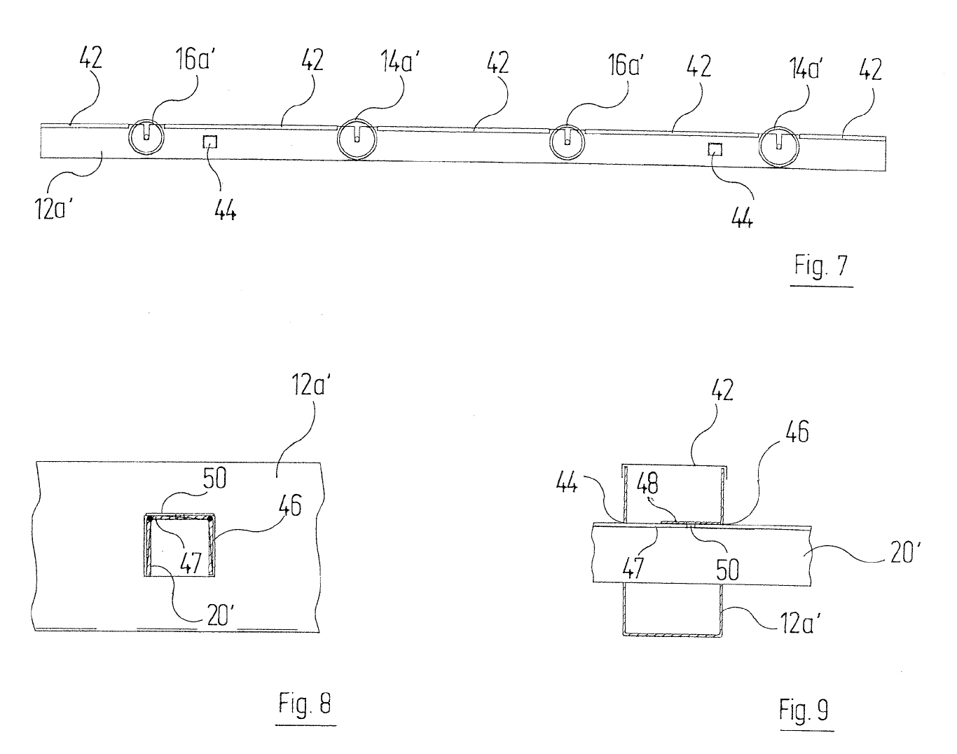

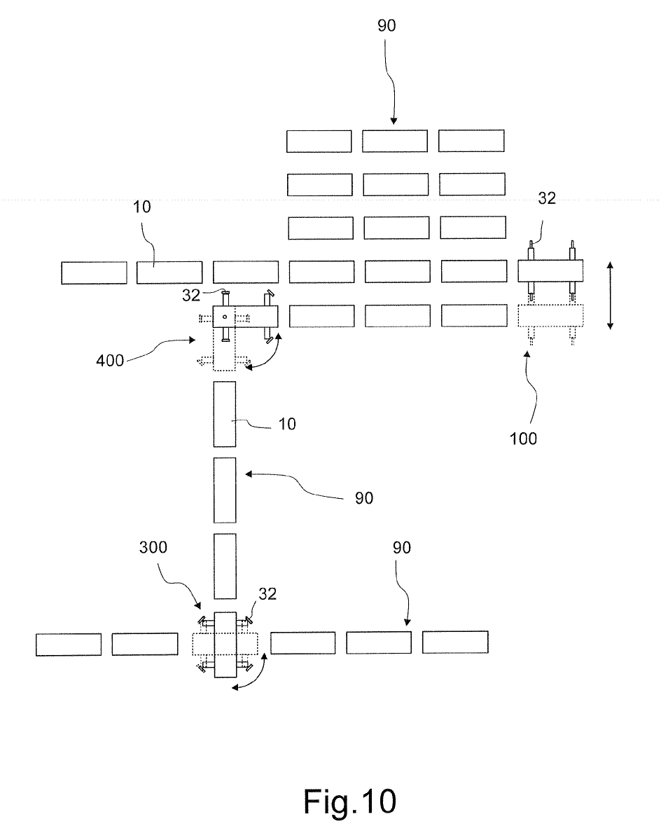

The roller path module 10′ has two roller strips 12a′, 12b′ which are arranged parallel to one another. As may be seen best in the cross section of FIG. 9, the roller strip 12a′ consists of a U-shaped profile, which is open at the top. In FIG. 9, a cover is indicated by 42, which closes the roller strip 12a′ at the top. Covers 42 are also visible in the longitudinal section of FIG. 7, but not shown in FIG. 6, in order to completely open up the view of the transport rollers 14a′ and the non-driven transport rollers 16a′ accommodated in the roller strips 12a′.

The driven transport rollers 14a′ are, as in the embodiment shown in FIG. 1, configured together with an individual electrical hub drive as compact sub-assemblies. These sub-assemblies have, in the same manner as the non-driven transport rollers 16a′, lateral guide webs, which are inserted into slot-like recesses and fixed there. The recesses extend in this case vertically down-wards from the free ends of the vertical side limbs of the U-shaped profile.

The two vertical side limbs of the roller strip 12a′ also have two through-passages, the spacing thereof being identical from the front faces of the roller strip 12a′. As may be seen in FIGS. 8 and 9, each through-passage is formed by a recess 44 on the external limb and a recess 46 on the inner limb of the roller strip 12a′. The recess 46 on the inner limb is produced by the inner limb being cut out along a line, which has the form of a U-shaped profile open at the top. The tab 48 produced thereby is bent to such an extent into the roller strip 12a′ until it extends horizontally.

The other roller strip 12b′ is configured in the same manner, in this case the driven trans-port rollers 14a′, 14b′ also being arranged offset to one another, as is also the case in the roller path module 10 shown in FIG. 1.

In the through-passages located at the same level in the roller strips 12a′, 12b′ transverse members 18′, 20′ are inserted such that the free ends of the transverse members 18′, 20′ project over the outer limbs of the roller strips 12a′, 12b′, as is best visible in FIG. 1. As FIG. 8 shows, the transverse members 18′, 20′ in the embodiment shown are configured as U-shaped profiles open at the bottom. The cross section of the U-shaped profiles should be dimensioned such that the transverse members 18′, 20′ may be passed with sufficiently large clearance through the recesses 44, 46 in the roller strips 12a′, 12b′. The transverse members 18′, 20′ are merely fastened to the roller strips 12a′, 12b′ on their upwardly facing surfaces 47. To this end, the tabs 48 bent upwards are screwed to these surfaces 47 of the transverse members 18′, 20′ or connected in a different manner. In FIGS. 6, 8 and 9, bores for a screw connection are indicated by the reference numeral 50.

Holders for rollers may be fastened to the outwardly projecting front faces of the trans-verse members 18′, 20′, in order to construct operation units on the basis of the roller path module 10′, as are shown from the principle in FIGS. 2 to 5. To this end the transverse members 18′, 20′ may have mating flanges (not shown) as are denoted in FIG. 2 by 30a, 30b. Holders for rollers may, however, naturally also be fastened in a different manner to the ends of the trans-verse members 18′, 20′.

If the roller path module 10′ is not intended to be part of an operation unit, as shown in FIGS. 2 to 5, but used for constructing a straight conveyor path, the transverse members 18′, 20′ may either be completely dispensed with or replaced by shorter transverse members, which do not laterally project beyond the roller strips 12a′, 12b′. In this manner, it is prevented that parts projecting laterally from the roller strips 12a′, 12b′, result in endangering personnel who remain in the vicinity of the conveyor path.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

1-36. (canceled)

37. A roller conveyor system for transporting goods carriers, comprising a plurality of identical roller path modules, wherein each of the identical roller path module comprises
a) two roller strips, which are arranged parallel to one another,
b) transport rollers which are supported by the roller strips and are configured to carry and transport a goods carrier on the roller path module, and
c) a drive which is configured to drive one or more of the transport rollers,
wherein some of the identical roller path modules are fixedly arranged in series one behind the other so as to form a conveyer path, and
wherein at least one of the identical roller path modules is connected to wheels so as to form an operation unit which is capable of being moved relative to the conveyer path.

38. The system of claim 36, wherein the operation unit is a transverse sliding carriage, and wherein the wheels connected to the at least one of the identical roller path modules have rotational axes which extend parallel to a longitudinal direction of the roller strips of the at least one of the identical roller path modules.

39. The system of claim 36, wherein the operation unit is a longitudinal sliding carriage, and wherein the wheels connected to the at least one of the identical roller path modules have rotational axes which extend at right angles to a longitudinal direction of the roller strips of the at least one of the identical roller path modules and parallel to a conveying plane defined by said roller strips.

40. The system of claim 39, wherein the operation unit is a turntable or a swivel table, and wherein the wheels connected to the at least one of the identical roller path modules have rotational axes which extend parallel to a conveying plane defined by the roller strips of the at least one of the identical roller path modules and obliquely to a longitudinal direction of said roller strips.

41. The system of claim 37, wherein the wheels are releasably connected to the at least one of the identical roller path modules.

42. The system of claim 37, comprising a first one of the identical roller path modules to which wheels having first rotational axes are connected, and a second one of the identical roller path modules to which wheels having second rotational axes are connected, wherein orientations of the first rotational axes differ from orientations of the second rotational axes.

43. The system of claim 37, wherein the identical roller path modules have side cheeks, and wherein the wheels of the operation unit are connected to the side cheeks of the at least one of the roller path modules.

44. The system of claim 37, wherein the roller strips of the identical roller path modules are connected in a transverse direction by hollow transverse members, wherein each of the identical roller path modules has channels that are defined by the hollow transverse members and through-passages in the roller strips, and wherein the wheels connected to the at least one of the roller path modules are fastened to a crossmember which is accommodated in one of the channels.

45. The system of claim 44, wherein the transverse members are hollow profiles or U-shaped profiles or C-shaped profiles.

46. The system of claim 44, wherein the transverse members are U-shaped profiles.

47. The system of claim 37, wherein each of the identical roller path modules has at least two driven transport rollers.

48. The system of claim 47, comprising individual drives for each of the at least two driven transport rollers.

49. The system of claim 37, wherein a spacing between the transport rollers is twice the size of a spacing between front faces of the roller path modules forming the conveyor path and a transport roller which is positioned closest to the front face.

50. The system of claim 37, comprising a first sub-assembly including a transport roller and a hub drive which is configured to drive said transport roller, and a second sub-assembly including a wheel and a hub drive which is configured to drive said wheel, wherein the first and the second sub-assemblies are completely identical with each other.

51. A roller conveyor system for transporting goods carriers, comprising:
a) a conveyer path which is formed by a plurality of identical roller path modules that are fixedly arranged in series one behind the other, wherein each of the identical roller path modules comprises
two roller strips, which are arranged parallel to one another, and
transport rollers which are supported by the roller strips and are configured to carry and transport a goods carrier on the roller path module,
b) a first operation unit which comprises
a first roller path module that is identical to the roller path modules that form the conveyer path, and
wheels that are connected to the first roller path module in a first arrangement so as to enable the first roller path module to move relative to the conveyer path,
c) a second operation unit which comprises
a second roller path module that is identical to the roller path modules that form the conveyer path, and
wheels that are connected to the second roller path module in a second arrangement so as to enable the second roller path module to move relative to the conveyer path,
wherein the first arrangement differs from the second arrangement.

52. A roller conveyor system for transporting goods carriers, comprising:
a) a conveyer path which is formed by a plurality of identical roller path modules that are fixedly arranged in series one behind the other, wherein each of the identical roller path modules comprises
two roller strips, which are arranged parallel to one another, and
transport rollers which are supported by the roller strips and are configured to carry and transport a goods carrier on the roller path module,
b) a first operation unit which comprises
a first roller path module that is identical to the roller path modules that form the conveyer path, and
wheels that are connected to the first roller path module in a first arrangement so as to enable the first roller path module to move relative to the conveyer path,

53. The system of claim 52, wherein the first and the second operation units are selected from the group consisting of: a turntable, a swivel table, a longitudinal sliding carriage and a transverse sliding table.

54. A roller conveyor system for transporting goods carriers, comprising:
a) a conveyer path which is formed by a plurality of identical roller path modules that are fixedly arranged in series one behind the other, wherein each of the identical roller path modules comprises
two roller strips, which are arranged parallel to one another, are connected to each other by hollow transverse members and have through-passages,
channels that are defined by the hollow transverse members and the through-passages, and
transport rollers which are supported by the roller strips and are configured to carry and transport a goods carrier on the roller path module,
b) an operation unit which comprises
a roller path module that is identical to the roller path modules that form the conveyer path, and
wheels that are connected to said roller path module so as to enable the roller path module to move relative to the conveyer path, wherein at least one wheel is fastened to a crossmember which is accommodated in one of the channels of said roller path module.
